(19) United States
(12) Patent Application Publication
(10) Pub. No.: US 2026/0315150 A1
(43) Pub. Date: Oct. 15, 2026

(54) MEDICAL IMAGING SYSTEMS AND METHODS FOR ANATOMICAL STRUCTURE THREE-DIMENSIONAL RECONSTRUCTION AND VOLUME DETERMINATION

(71) Applicant: Boston Scientific Scimed, Inc., Maple Grove, MN (US)

(72) Inventor: Veerakumar VENUGOPAL, Carver, MN (US)

(73) Assignee: Boston Scientific Scimed, Inc., Maple Grove, MN (US)

(21) Appl. No.: 19/639,395

(22) Filed: Apr. 6, 2026

Related U.S. Application Data
(60) Provisional application No. 63/786,411, filed on Apr. 10, 2025.

(51) Int. Cl. A61B 34/10; A61F 5/00; G06T 7/55; G06T 17/20; G06T 19/20; A61B 34/00; A61B 90/00

(52) U.S. Cl. CPC A61B 34/10; A61F 5/0083; G06T 7/55; G06T 17/20; G06T 19/20; A61B 2034/105; A61B 2034/252; A61B 2090/367; G06T 2210/41; G06T 2219/2021

(57) ABSTRACT

A plurality of images of an anatomical structure captured by a medical imaging device are received as a medical procedure is initiated. A three-dimensional (3D) model of the anatomical structure is reconstructed based on the plurality of images. An overlay including the 3D model is generated for display on an image from the plurality of images, and an initial volume of the anatomical structure is determined using the 3D model. The 3D model is updated as additional images of the anatomical structure captured by the medical imaging device are received throughout the medical procedure. The overlay and the initial volume are adjusted based on the updated 3D model to monitor changes in one or more of a shape or a volume of the anatomical structure, upon which one or more steps of the medical procedure are performed based on, throughout the medical procedure.

### CROSS-REFERENCE TO RELATED APPLICATIONS

This application claims priority to U.S. Provisional Application No. 63/786,411, filed on Apr. 10, 2025, which is incorporated by reference herein in its entirety.

### TECHNICAL FIELD

The disclosure relates generally to systems and methods for medical image processing. More specifically, aspects of the disclosure pertain to systems and methods for medical image processing to reconstruct three-dimensional models of an anatomical structure for display and to determine volume of the anatomical structure in real time throughout a medical procedure.

### BACKGROUND

A medical system may include a medical device, such as an endoscope, that is removably connectable to a computing system to perform a medical procedure. For example, the endoscope may be inserted into and navigated through a body lumen of a patient to a target site during a medical procedure. The endoscope may include an imaging device configured to capture images, as well as a lighting device configured to illuminate the target site to facilitate visualization of anatomical structures or features or other objects at the target site. The computing system may receive and process the captured images, and display the processed images for viewing by an operator (e.g., an endoscopist) in real time.

Endoscopic Sleeve Gastroplasty (ESG) is a minimally invasive weight-loss procedure that involves the use of an endoscope and a suturing device removably attached to a distal end of the endoscope. The suturing technique implemented in ESG to reduce a size of the stomach involves several steps and considerations to ensure the procedure is effective and safe, including determinations of suturing locations, a pattern and number of sutures, and when to complete suturing. Each of these steps and considerations may depend on a shape or size of the stomach, which may change dynamically throughout the procedure.

### SUMMARY

According to some aspects, the techniques described herein relate to a computer-implemented method for monitoring changes to an anatomical structure throughout a medical procedure. An example method includes: receiving a plurality of images of the anatomical structure captured by a medical imaging device as the medical procedure is initiated, wherein one or more steps of the medical procedure are performed based on one or more of a shape or a volume of the anatomical structure, and the shape and the volume of the anatomical structure change throughout the medical procedure; reconstructing a three-dimensional (3D) model of the anatomical structure based on the plurality of images; generating an overlay including the 3D model for display on an image from the plurality of images; determining an initial volume of the anatomical structure using the 3D model; and updating the 3D model as additional images of the anatomical structure captured by the medical imaging device are received throughout the medical procedure, wherein the overlay and the initial volume are adjusted based on the updated 3D model to monitor the changes to the shape or the volume of the anatomical structure throughout the medical procedure.

In any of the example methods disclosed herein, reconstructing the 3D model includes: detecting and extracting features from the plurality of images; identifying a correspondence among the features across the plurality of images; determining depth data for the features using the identified correspondence across the plurality of images; generating a point cloud including points associated with the features using the plurality of images and the depth data; and generating the 3D model of the anatomical structure based on the point cloud. Determining the depth data for the features includes determining a depth of each feature based on one of: a difference determined between a position of the feature in a first image, from the plurality of images, associated with a first viewpoint of the feature and a second image, from the plurality of images, associated with a second viewpoint of the feature; a difference determined between positions of the feature in a pair of consecutive images, from the plurality of images, identified as failing to meet a similarity threshold; or intensity values of pixels associated with the feature across the plurality of images.

In some examples, generating the point cloud includes establishing a 3D point for each feature using x- and y-coordinate positions for the feature obtained from the plurality of images and a z-coordinate position for the feature obtained from the depth data. Generating the 3D model of the anatomical structure based on the point cloud includes: connecting the points in the point cloud to form a 3D mesh representing a geometry of the anatomical structure; and texturizing the 3D mesh by adding image properties from the plurality of images to generate the 3D model. A Structure for Motion (SfM) technique, a Simultaneous Localization and Mapping (SLAM) technique, or a combination of the SfM technique and the SLAM technique are configured to reconstruct the 3D model. One or more preprocessing operations are performed on the plurality of images to generate a plurality of enhanced images, and the 3D model of the anatomical structure is reconstructed based on the plurality of enhanced images.

In other examples, determining the initial volume of the anatomical structure includes integrating 3D data points within a defined boundary of the 3D model representing the anatomical structure. The defined boundary is defined by one or more of naturally occurring anatomical features of the anatomical structure or predefined endpoints. The initial volume and adjustments to the initial volume are provided for display throughout the medical procedure. The initial volume and the adjustments to the initial volume are included in the overlay and the adjusted overlay, respectively.

In further examples, the medical procedure is associated with a volume reduction of the anatomical structure from the initial volume to a target volume, and the method further includes: determining, based on the adjustment to the initial volume, the target volume has been reached; and generating, and providing for display, a notification that the target volume has been reached.

In some examples, generating the overlay includes: determining an alignment between the 3D model and the image such that x- and y-coordinate positions for feature points identified in the 3D model correspond with x- and y-coordinate positions for corresponding feature points in the image; and generating an overlay image for display by overlaying the 3D model on the image based on the alignment.

In other examples, the medical procedure includes a suturing procedure, and one step of the one or more steps of the medical procedure performed based on the one or more of the shape or the volume of the anatomical structure is a determination of a plurality of locations to place a plurality of sutures. In such examples, the plurality of locations to place the plurality of sutures are determined based on the 3D model. In further examples, the 3D model includes a plurality of markings that were placed on the anatomical structure to correspond to a plurality of suture locations based on a presence of the plurality of markings in at least a subset of the plurality of images, and updating the 3D model includes: reconstructing the updated 3D model based on the additional images and the 3D model to cause remaining markings of the plurality of markings to be included in the updated 3D model even when the remaining markings are not visible in the additional images received.

In further examples, the anatomical structure is a stomach, and the medical procedure is an endoscopic sleeve gastroplasty performed to reduce a volume of the stomach.

According to other aspects, the techniques described herein relate to a computer-implemented method for monitoring changes to an anatomical structure throughout a medical procedure. An example method includes: receiving a plurality of images of the anatomical structure captured by a medical imaging device as the medical procedure is initiated, wherein the medical procedure is associated with a volume change of the anatomical structure; determining depth data associated with the plurality of images; reconstructing a three-dimensional (3D) model of the anatomical structure based on the plurality of images and the depth data; determining an initial volume of the anatomical structure using the 3D model; and updating the 3D model as additional images of the anatomical structure captured by the medical imaging device are received throughout the medical procedure, wherein the initial volume determined is adjusted based on the updated 3D model to monitor the volume change of the anatomical structure throughout the medical procedure.

In some examples, an overlay including the 3D model is generated for display on an image from the plurality of images, where the overlay is adjusted based on the updated 3D model. In other examples, the initial volume and the adjusted volume are caused to be displayed as part of the overlay and the adjusted overlay, respectively.

According to further aspects, the techniques described herein relate to a computer-implemented method for monitoring changes to an anatomical structure throughout a medical procedure. An example method includes: receiving a plurality of images of the anatomical structure captured by a medical imaging device as the medical procedure is initiated, wherein the medical procedure includes suturing to reduce a volume of the anatomical structure, and wherein at least a subset of the plurality of images include a plurality of markings placed on the anatomical structure at a plurality of suture locations; determining depth data associated with the plurality of images; reconstructing a three-dimensional (3D) model of the anatomical structure based on the plurality of images and the depth data, the 3D model including the plurality of markings; generating an overlay including the 3D model for display on an image from the plurality of images; and updating the 3D model as additional images of the anatomical structure captured by the medical imaging device are received throughout the medical procedure, wherein the overlay is adjusted based on the updated 3D model to monitor changes to a shape and size of the anatomical structure as the suturing is performed to reduce the volume of the anatomical structure, and wherein the updated 3D model maintains remaining markings of the plurality of markings to facilitate the suturing.

In some examples, an initial volume of the anatomical structure is determined using the 3D model. The initial volume determined is adjusted based on the updated 3D model to monitor a volume change of the anatomical structure throughout the medical procedure.

It may be understood that both the foregoing general description and the following detailed description are exemplary and explanatory only and are not restrictive of the invention, as claimed. As used herein, the terms “comprises,” “comprising,” “includes,” “including,” “has,” “having,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. The term “exemplary” is used in the sense of “example,” rather than “ideal.” The term “distal” refers to a direction away from an operator/toward a treatment site, and the term “proximal” refers to a direction toward an operator. The term “approximately,” or like terms (e.g., “substantially”), includes values +/- 10% of a stated value.

### BRIEF DESCRIPTION OF THE DRAWINGS

The accompanying drawings, which are incorporated in and constitute a part of this specification, illustrate examples of this disclosure and, together with the description, serve to explain the principles of the disclosure.

FIG. 1 depicts an example medical system.

FIG. 2 depicts an example process for three-dimensional (3D) reconstruction and volume determination of an anatomical structure.

FIG. 3 depicts an example process for reconstructing a 3D model of the anatomical structure.

FIG. 4 is a block diagram depicting example processes for training, using, and monitoring a machine learning model executed as part of the 3D reconstruction process.

FIG. 5 depicts an example 3D model of the anatomical structure overlaid on an image of the anatomical structure.

FIG. 6 depicts an example computing device.

### DETAILED DESCRIPTION

As briefly mentioned above, Endoscopic Sleeve Gastroplasty (ESG) is a minimally invasive weight-loss procedure that involves the use of an endoscope and a suturing device removably attached to a distal end of the endoscope. The suturing technique implemented in ESG to reduce a size (e.g., a volume) of the stomach may involve several steps and considerations that depend on the shape, size, or both the shape and size of the stomach to help ensure the procedure is effective and safe.

In some cases, desired suture locations may be determined based on the shape of the stomach. For example, in a J-shaped stomach, sutures may be desired to be placed along the greater curvature of the stomach, starting from the antrum, and moving upwards towards the fundus. In an elongated stomach, sutures may be desired to be placed more evenly along the length of the stomach, while in a rounded stomach, the sutures may be desired to be placed such that an overall circumference of the stomach is reduced to create a tubular shape. The determined desired suture locations may be marked along the stomach at the beginning of the procedure in a manner that can be visually captured by the endoscope to help guide suture placement throughout the procedure. For example, plasma coagulation may be used to mark the suture locations along the stomach.

Additionally, during the procedure, the endoscopist may use a specific suture pattern, such as a square or a rectangular suture pattern. The sutures may be desired to be placed in a way that reduces the size of the stomach in a tube-like manner to help maintain the structural integrity of the stomach and avoid complication. A number of sutures placed may be variable. However, four to six sutures may be a common standard, with each suture involving more than eight to ten bites. To determine when to complete the suturing, the endoscopist may monitor the shape and size of the stomach throughout the procedure. For example, a diameter of the gastric outlet of the stomach may be monitored to reach a target diameter value or the stomach may be monitored to help achieve a uniform reduction in the stomach, particularly for certain stomach shapes. For example, in a J-shaped stomach, the curvature may require careful placement of sutures to help ensure the stomach is uniformly reduced in size without creating undue tension on the sutures.

However, throughout the ESG procedure, changes in the shape and size of the stomach resulting from forces exerted during the procedure (e.g., suturing, gas introduction or removal, etc.), as well as natural processes (e.g., peristalsis), may make visualization of marked suture locations and general monitoring of the shape and size of the stomach challenging. For example, as suturing begins at the first marked suture location, a contour of the stomach may change as a result of the suture placed that may make it difficult to visualize a subsequent suture marking via the imaging device of the endoscope. As one illustrative example, the placement and tightening of the first suture may cause gastric folds of the stomach to shift or adjust in a manner that hides or otherwise obscures the subsequent suture marking.

This challenge associated with visualization of suture location may be compounded by the use of an accessory tool of the suturing device (e.g., a tissue helix component) for grasping and retracting tissue to facilitate suturing. For example, the tool may be advanced through a working channel of the endoscope and into tissue at the target site to grasp a section of tissue including the first suture location marking. This tool may then be retracted back towards the endoscope to pull the tissue section outward to facilitate a first suture at the marked location. Due to a lack of visibility created as the tissue is retracted, there may be a potential that a subsequent suture will cross the first suture because of not knowing the exact location of the subsequent suture as a result of the hidden or obscured subsequent suture marking.

Another challenge may be determining when to stop suturing. As mentioned above, there may be standards as to a number of sutures to reach a target volume of the stomach. However, changes to the stomach occurring from various causes during the procedure may result in the target volume being reached with a lesser number of sutures than the standards specify. Further complexity to the above-described determinations made in association with the shape and size of the stomach throughout the procedure is added because an entirety of the stomach is not able to be visualized from images captured from within the interior of the stomach by the endoscope.

To address and overcome these challenges, systems and methods are described herein for three-dimensional (3D) reconstruction and volume determination of an anatomical structure in real time during an endoscopic procedure, such as the stomach during an ESG. For example, a 3D model of the stomach may be reconstructed from two-dimensional (2D) images captured by the endoscope, and updated in real time throughout the procedure leveraging one or more advanced machine learning algorithms, such as Structure from Motion (SfM), Simultaneous Localization and Mapping (SLAM), or a combination of techniques from SfM and SLAM. The 3D model and subsequently updated 3D models may be used to generate and continuously adjust an overlay that aligns the 3D model with a currently displayed image captured by the endoscope to facilitate an endoscopist's visualization of the stomach, where the models include any suture markings that may otherwise be hidden or obscured from the view of the endoscope's imaging device. Additionally, the 3D model and subsequently updated 3D models may be used to continuously determine the volume of the stomach as it is being reduced throughout the ESG.

The specific examples described herein implement the 3D reconstruction and volume determination for the stomach during an ESG. However, it should be understood that techniques described herein may be adapted to other procedures associated with a variety of anatomical structures, and particularly other endoscopic procedures involving volume changes to anatomical structures. It should also be understood that the examples above are illustrative only. The techniques and technologies described herein may be adapted to any suitable activity.

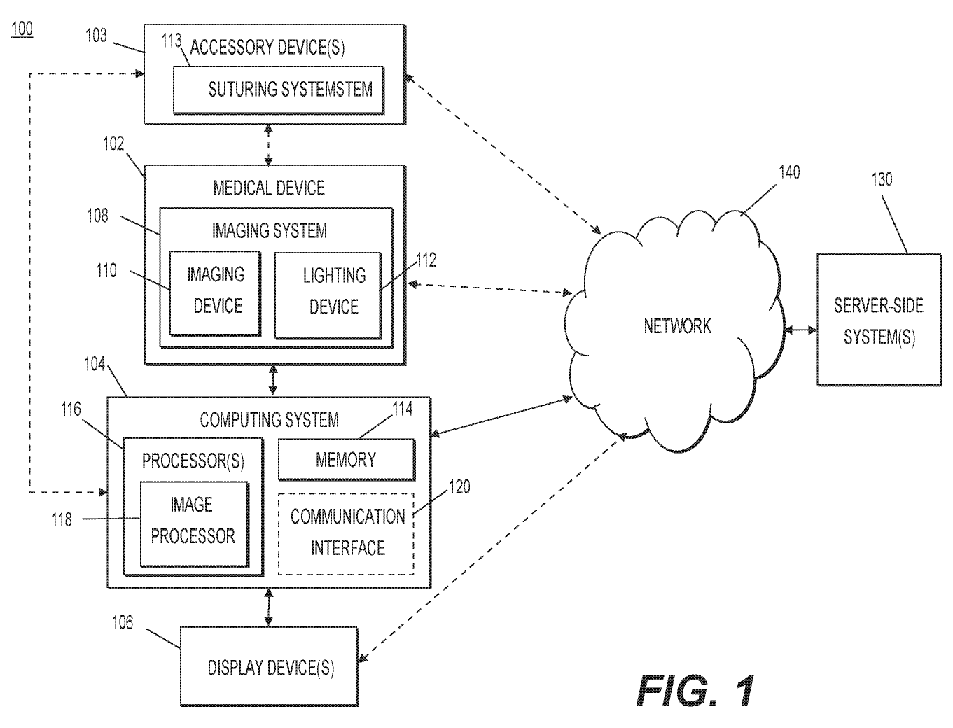

FIG. 1 depicts an example medical system 100. Medical system 100 may include a medical device 102, one or more accessory device(s) 103, a computing system 104, one or more display device(s) 106, one or more server-side system(s) 130, and a network 140.

Medical device 102 may be used to perform a diagnostic or interventional medical procedure on a patient upon connection with computing system 104. Medical device 102 may be an endoscope or other type of scope, such as a bronchoscope, ureteroscope, duodenoscope, cholangioscope, gastroscope, endoscopic ultrasonography ("EUS") scope, colonoscope, laparoscope, arthroscope, cystoscope, aspiration scope, sheath, or catheter, among other examples.

In some examples, medical device 102 may be a single use device that is discarded or disposed of upon disconnection from computing system 104 (e.g., at an end of the medical procedure). Therefore, although only one medical device 102 is shown in FIG. 1, medical system 100 may include one or more other medical devices 102 that are the same or similar to medical device 102, where the other medical devices 102 may also be removably connected to computing system 104 for performing medical procedures. Additionally, in some examples, different types of medical devices may be connectable to computing system 104 simultaneously with or independently from medical device 102.

Medical device 102 may be comprised of a handle, a shaft, and an umbilicus. At least a portion of the shaft, including a distal end of shaft, may be inserted into and navigated through a body lumen of a patient to a target site during a medical procedure, such that distal end is positioned proximate to the target site. Distal end may include distal openings for one or more of a working channel, an insufflation channel, or a fluid irrigation channel. Working channel may be a lumen that extends through the shaft and provides for delivery of instruments or treatment objects to the target site or removal of objects from the target site at distal end. Working channel may also provide suctioning functionality. The insufflation channel may be a lumen that extends through shaft and provides insufflation at distal end. The fluid irrigation channel may be a lumen that extends through the shaft and provides irrigation functionality at distal end to increase visualization, for example. In some examples, the insufflation and fluid irrigation channel may be a same channel. The distal end may also include one or more components of an imaging system 108.

Imaging system 108 may include at least one imaging device 110 and at least one lighting device 112. Imaging device 110 may be located at a distal end of medical device 102 (e.g., at a distal tip of medical device 102). Imaging device 110 may be configured to continuously capture image signals as the distal end of medical device 102 is inserted into and navigated through a body lumen of the patient to a target site during the medical procedure. Imaging device 110 may include one or more cameras, one or more image sensors, or one or more endoscopic viewing elements, among other similar devices.

In some examples, lighting device 112 may be located at the distal end of medical device 102 (e.g., at the distal tip of medical device 102) along with imaging device 110. In other examples (not shown), lighting device 112 may be a separate device or may be integrated with computing system 104, with light from lighting device 112 being transmitted via fibers (e.g., optical fibers) extending a length of medical device 102 (e.g., from a proximal end of medical device 102 connected to computing system 104 to the distal tip of medical device 102). Lighting device 112 may be configured to illuminate areas of the patient's body (e.g., the target area) during the medical procedure to facilitate imaging of the target area by imaging device 110. Lighting device 112 may include one or more LEDs, incandescent light sources, optical fibers (e.g., optical fibers to transmit a light from a proximal light source), or other illuminators.

Optionally, the distal end of medical device 102 may also include sensors located near imaging device 110 that are configured to detect a position of the distal end of medical device 102 and the components thereof. In some examples, the sensors may be planar sensors that are arranged on a surface of cables of imaging system 108 to obtain positional information of imaging device 110. In such examples, positional data collected by these sensors may be provided, along with the images captured by imaging device 110, for processing to perform the 3D model reconstruction and volume determination.

The handle may include one or more actuators. The actuators may provide control over a steerable section at the distal portion of the shaft (e.g., having an articulation joint), an elevator, or imaging functions at the distal end of shaft, as well as allow for the provision of air, water, suction, etc. For example, the handle may include control knobs for left, right, up, or down control of the steerable section of shaft. For example, one of control knobs may provide left/right control of the steerable section, and the other of control knobs may provide up/down control of the steerable section. The handle may further include one or more locking mechanisms (e.g., knobs or levers) for preventing steering or braking of the steerable section in at least one of an up, down, left, or right direction. The handle may include an elevator control lever (e.g., if medical device is a duodenoscope or an endoscopic ultrasound scope). The elevator control lever may raise or lower an elevator, via a connection between the lever and an actuating wire that extends from the lever, through shaft, to the elevator.

The umbilicus connects the handle, the shaft, the distal end, and the components at the distal end (e.g., imaging system 108) to one or more sources of, for example, power, imaging device control, image processing, light, light control, or display equipment. As one example, the umbilicus connects to computing system 104 (e.g., via a connector plug), and supports the transmission of various data signals between computing system 104 and medical device 102. For example, the umbilicus may support the transmission of data between medical device 102 and computing system 104 to facilitate communication establishment and set-up of operating parameters. Additionally, the umbilicus may support the transmission of power and control signals from computing system 104 to medical device 102, and particularly to imaging system 108. Further, the umbilicus may support the transmission of image data from imaging system 108 to computing system 104 for processing and display via display device(s) 106.

Accessory device(s) 103 may be separate systems, devices, tools, or instruments used in conjunction with medical device 102 to perform one or more operations during the medical procedure. For example, when the medical procedure is the endoscope-guided ESG procedure, accessory device(s) 103 may include at least a suturing system 113. Suturing system 113 may attach or otherwise couple to a distal end of medical device 102. For example, at least a portion of suturing system 113 may be configured as a cap that couples to or slides over the distal tip of medical device 102. One example type of suturing system 113 may be the Overstitch™ Endoscopic Suture System. In addition to suturing components, suturing system 113 may include a component for grasping and retracting tissue to facilitate suturing. For example, the tool may be a tissue helix component that is advanced through a working channel of medical device 102 and into tissue at the target site to grasp a section of tissue into which a suture is to be placed. This tool is then retracted back towards the endoscope to pull the tissue section outward to facilitate the suture.

One or more components of medical device 102, including imaging system 108 and the components thereof, may be communicatively coupled to computing system 104 via wired connections or wireless connections (e.g., over network 140) to enable communication of various signals between medical device 102 and computing system 104. For example, image signals captured by imaging device 110 (e.g., raw image data) may be received by computing system 104. Additionally, computing system 104 may provide one or more signals to the imaging device 110 or lighting device 112 to cause one or more parameters of imaging device 110 or lighting device 112, respectively, to be adjusted. Optionally, one or more components of accessory device(s) 103, including suturing system 113, may be communicatively coupled to medical device 102 or computing system 104 via wired connections or wireless connections (e.g., over network 140) to enable communication.

In some examples, computing system 104 is a controller, a control unit, a computing device, or other similar standalone processing unit separate from medical device 102. In other examples, computing system 104 may be partially or fully integrated with medical device 102. For example, computing system 104 may be partially or fully positioned in the handle of medical device 102. As another example, computing system 104 may be partially or fully positioned at the distal end of medical device 102. Computing system 104 may be or at least include a field-programmable gate array (FPGA) comprising programmable logic blocks for performing various functions.

Computing system 104 may include at least one memory 114, one or more processor(s) 116, and at least one communication interface 120. In some examples, memory 114, processor(s) 116, and communication interface 120, may be embedded on a printed circuit board (PCB) forming a system-on-module (SOM) of computing system 104. Memory 114 may store instructions to be executed by processor(s) 116 to cause computing system 104 to perform corresponding operations. At least a portion of the instructions stored in memory 114 may include instructions for 3D reconstruction and volume determination. Memory 114 may also store any models, algorithms, or other processes that are executable to perform the operations, such as one or a combination of the SfM or SLAM algorithms. Memory 114 may include one or more data stores for such storage. Additionally or alternatively, computing system 104 may include one or more data stores separate from memory 114 for such storage. Processor(s) 116 may include at least one image processor 118. Image processor 118 may be configured to process one or more image signals (e.g., raw image data) captured by imaging device 110 and received by computing system 104 to generate an image. Image processor 118 may also perform at least some steps or operations associated with the 3D reconstruction and volume determination processes independently or in conjunction with one or more other processor(s) 116. In some examples, image processor 118 may be or include an FPGA, a digital signal processing (DSP) processor, a graphics processing unit (GPU), or the like.

As mentioned above, in some examples, computing system 104 may include its own GPU or similar processor for executing the image processing. In other examples, one or more edge devices, such as edge artificial intelligence (AI) devices, may be integrated with the SOM and FPGA of computing system 104 to facilitate one or more image processing aspects.

In some examples, the 3D reconstruction and volume determination processes may be features of computing system 104 that can be manually enabled and disabled (e.g., turned on and off) by the operator. For example, graphical user interface control elements generated and provided for display by computing system 104 or buttons on medical device 102 may be actionable to turn one or more of the features on and off. In other examples, these features may be automatically enabled in response to computing system 104 determining an ESG or other similar type of procedure is being performed (e.g., based on input received from operator or patient data obtained indicating a type of procedure to be performed).

In some examples, one or more of the 3D reconstruction and volume determination processes being executed by computing system 104 may include the use or application of one or more machine learning models. As used herein, and as described in more detail herein, a machine learning model generally encompasses instructions, data, or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration. By virtue of such training, a machine learning model is converted from an un-trained and un-specific model to a model that is unique to and specifically configured for the particular purpose for which it is trained. In an example, training of a machine learning model is analogous to a method of production in which the article produced is the trained model having unique characteristics by virtue of its particular training. Moreover, the result of training a machine learning model using particular training data and for a particular purpose results in a technical solution to an inherently technical problem.

The execution of the machine learning model may include deployment of one or more machine learning techniques, such as linear regression, logistical regression, random forest, gradient boosted machine (GBM), deep learning, or a deep neural network. Supervised or unsupervised training may be employed. For example, supervised learning may include providing training data and labels corresponding to the training data, e.g., as ground truth. Unsupervised approaches may include clustering, classification, or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

In some examples, one or more aspects of the 3D reconstruction or volume determination may be performed by a separate device or system communicatively coupled to computing system 104. For example, another local machine, such as a controller, a control unit, a computing device, or other similar standalone processing unit (e.g., the above-described edge AI device) may be coupled to computing system 104, and configured to store and execute instructions for performing the 3D reconstruction or volume determination. The other local machine may be dedicated to performing the 3D reconstruction or volume determination, for example. As another example, a remote system, such as one of server-side system(s) 130, described below, may be configured to store and execute instructions for performing the 3D reconstruction or volume determination.

Computing system 104 may further include a communication interface 120 for providing connectivity to network 140. Communication interface 120 may also provide connectivity to medical device 102 or display device(s) 106. In some examples, a communicative connection between computing system 104 and medical device 102 (or components thereof) or computing system 104 and display device(s) 106 may be at least partially supported via network 140.

Although only one computing system 104 is shown in FIG. 1, in some examples, medical system 100 may include one or more other computing systems 104 that are the same or similar to computing system 104 to which medical device 102 may also be removably connected to, as described below. To provide an illustrative example, within a medical facility, multiple procedural suites may each include one computing system 104 that remains located in that suite.

Display device(s) 106 may be configured to display image data, including at least the images and 3D model overlays generated by computing system 104, as well as volume data as part of or independent from the overlays. Display device(s) 106 may include one or more a combination of monitors, computing device screens, touch screen display devices, etc. In some examples, one or more of display device(s) 106 may be a separate device from computing system 104 that is communicatively coupleable to computing system 104 via wired or wireless connections. In other examples, at least one of display device(s) 106 may be a display of computing system 104 itself.

In some examples, computing system 104 may generate, or may cause to be generated, one or more graphical user interfaces based on instructions or information stored in memory 114, instructions or information received from one or more server-side system(s) 130, or the like and may cause the graphical user interfaces to be displayed via display device(s) 106. The graphical user interfaces may be, e.g., application interfaces or browser user interfaces and may include text, selection controls, or the like, in addition to the displayed image data.

Display device(s) 106 may include a touch screen or a display with other input systems (e.g., a mouse, keyboard, voice, etc.) for an operator of computing system 104 to control functions of computing system 104, medical device 102 (or components thereof), or accessories device(s) 103 via computing system 104, or display device(s) 106. As one example, the operator may select one or more of the control elements displayed on a graphical user interface of display device(s) 106 to enable (e.g., turn on) one or more features, such as the 3D reconstruction and volume determination features. As another example, the operator may select one or more of the control elements displayed on a graphical user interface of display device(s) 106 to manually adjust one or more operating parameters of imaging system 108 (e.g., based on operator preferences). The selection may be received by computing system 104 and cause corresponding signals to be transmitted from computing system 104 to imaging system 108 or specific components thereof.

One or more components of medical system 100, such as medical device 102, accessory device(s) 103, computing system 104, or display device(s) 106, may be capable of network connectivity, and may communicate with one another over a wired or wireless network, such as network 140. Network 140 may be an electronic network. Network 140 may include one or more wired or wireless networks, such as a wide area network ("WAN"), a local area network ("LAN"), personal area network ("PAN"), a cellular network (e.g., a 3G network, a 4G network, a 5G network, etc.), or the like. In other examples, the components of medical system 100 may communicate or connect to network 140 over universal serial bus (USB) or other similar local, low latency connections or direct wireless protocol. Components of medical system 100 may be connected via network 140, using one or more standard communication protocols, such that the component may transmit and receive communications from each other across network 140.

In some examples, when one or more of the components of medical system 100 are capable of connecting to network 140, medical system 100 may also include one or more server-side system(s) 130. One or more of server-side system(s) 130 may be configured to generate or train one or more of the machine learning models to provide to computing system 104 for local storage and execution. In some examples, the same or different server-side system(s) 130 may include remote image processing systems configured to optionally perform a portion of the image processing, including but not limited, more resource intensive processes (e.g., to conserve local resources of computing system 104 when network connectivity is available). Additionally or alternatively, server-side system(s) 130 may include remote data storage systems for storing data generated by computing system 104 (e.g., image data, 3D model overlays, volume data, or other data). In some examples, at least one of the data storage systems may include a picture archiving and communication system (PACS) that stores the image, along with other types of imaging data from various imaging modalities (e.g., ultrasound, magnetic resonance, nuclear medicine imaging, positron emission tomography, computed tomography, mammograms, digital radiography, histopathology, etc.) associated with the patient.

Although various components in medical system 100 are depicted as separate components in FIG. 1, it should be understood that a component or portion of a component in medical system 100 may, in some examples, be fully or partially integrated with or incorporated into one or more other components. For example, one of display device(s) 106 may be integrated with computing system 104 or computing system 104 may be integrated with medical device 102. In some aspects, operations or aspects of one or more of the components discussed above may be distributed amongst one or more other components. Any suitable arrangement or integration of the various systems and devices of medical system 100 may be used.

The specific examples described herein implement an endoscopic imaging system configured to perform 3D reconstruction and volume determination of an anatomical structure in real time during a medical procedure. However, it should be understood that techniques described herein may be adapted to other medical imaging systems. It should also be understood that the examples above are illustrative only. The techniques and technologies described herein may be adapted to any suitable activity.

Additionally, presented below are various aspects of machine learning techniques that may be adapted to perform the 3D reconstruction and volume determination. As will be discussed in more detail below, these machine learning techniques may include, e.g., a particular selection of training data, a particular training process for the machine learning model, operation of a particular device or system suitable for use with the trained machine learning model, operation of the machine learning model in conjunction with particular data, modification of such particular data by the machine learning model, etc., or other aspects that may be apparent to one of ordinary skill in the art based on the description herein.

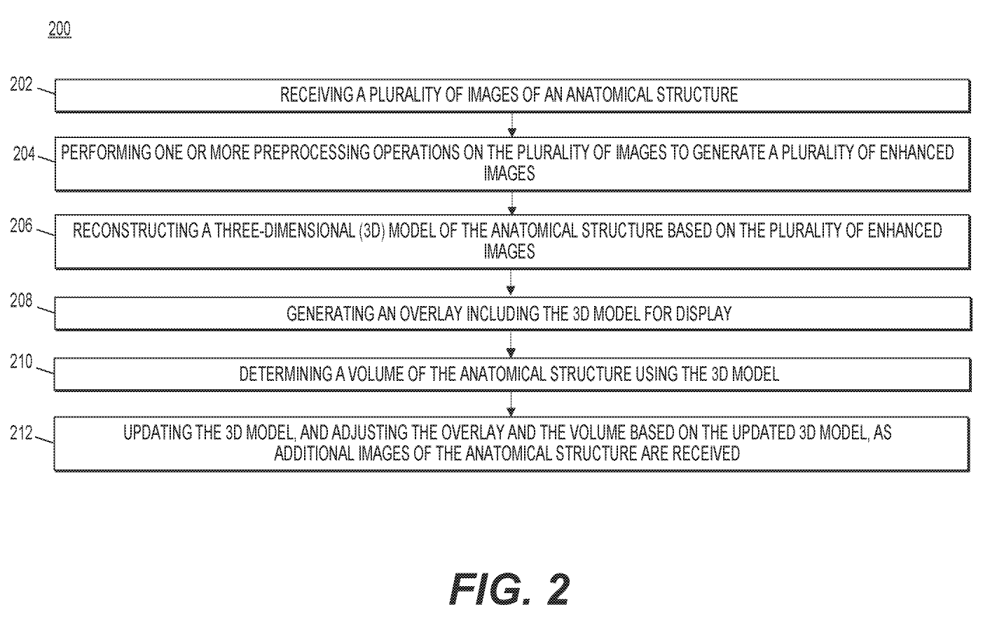

FIG. 2 depicts a flowchart of a process 200 for a 3D reconstruction and volume determination of an anatomical structure performed by medical system 100 of FIG. 1. In some examples, one or more steps of process 200 may be performed by computing system 104.

At step 202, process 200 may include receiving a plurality of images of an anatomical structure. The anatomical structure may be a stomach to be reduced as part of an ESG procedure. The images may be captured by, and received from, imaging device 110 as medical device 102 is being inserted into and navigated to a target site in an interior of the stomach. For example, images of the stomach lining and gastric folds may be captured from a plurality of different angles as a result of imaging device 110 being positioned at different locations as the images are captured. In some examples, a predefined set of angles for image capture may be determined. The predefined set of angles may be a minimum number and order of images at particular angles needed to perform the 3D reconstruction (e.g., minimum input to the machine learning model(s)), as described with reference to step 206 below. Based on the predefined set of angles determined, a corresponding position or movement of medical device 102 to obtain the predefined set of angles may be determined. In some aspects, the position or movement of medical device 102 may be tracked and guidance (e.g., instructions or alerts) may be generated and provided to the operator to help facilitate capture of the images according to the predefined set.

Once medical device 102 has been navigated to the target site, suture locations may be determined, and marked along the stomach in a manner that can be visually captured by imaging device 110 to help guide suture placement throughout the procedure. For example, plasma coagulation may be performed to generate the markings, which results in a different color and texture from surrounding tissue in the stomach to allow visualization of the markings in at least a subset of the images received at step 202. Accordingly, in some examples, a subset of the images received at step 202 may include the suture location markings. In other examples, the images received at step 202 and used as a basis for at least a first instance of 3D reconstruction (e.g., an initial 3D model generated) may include only images captured prior to the marking to help facilitate the marking, as discussed in more detail below. In such examples, the images including the suture location markings may be used as a basis for a subsequent instance of 3D construction (e.g., to update the initial 3D model generated).

The images captured by and received from imaging device 110 are 2D images comprised of a plurality of pixels. The pixels may be in a form of a 2D pixel grid with each pixel having an x-coordinate position and a y-coordinate position in the pixel grid.

At step 204, process 200 may include performing one or more preprocessing operations on the plurality of images to generate a plurality of enhanced images. The preprocessing operations may include one or a combination of image enhancement techniques to improve a quality of the images, such as noise reduction or contrast enhancement. One example technique may include contrast-limited adaptive histogram equalization (CLAHE).

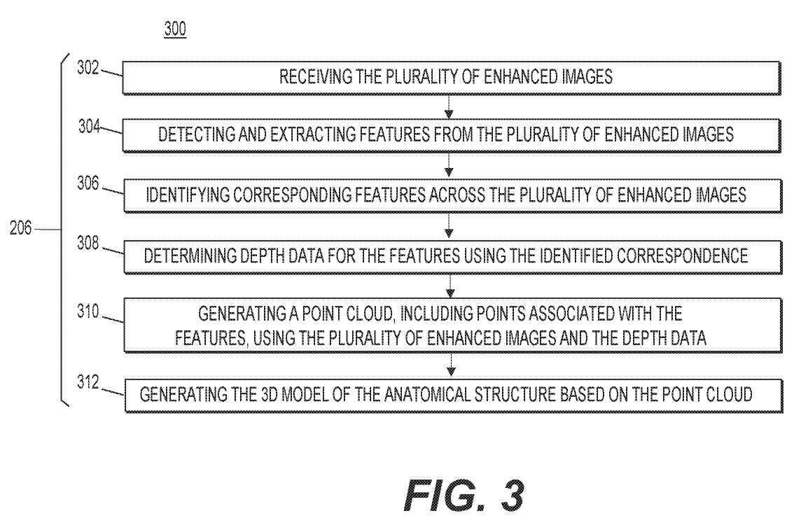

At step 206, process 200 may include reconstructing a 3D model of the anatomical structure based on the plurality of enhanced images (e.g., performing 3D reconstruction). 3D reconstruction may include generating, building, or otherwise constructing the 3D model of the anatomical structure using (i) the enhanced images and (ii) depth data determined from the enhanced images to represent a shape and appearance of the anatomical structure in real time during the procedure. Turning to FIG. 3, FIG. 3 describes a process 300 for reconstructing the 3D model of the anatomical structure. Process 300 may be used to perform at least a portion of step 206 of process 200. Process 300 may be performed by one or more machine learning models executed by computing system 104 that are trained to perform one or a combination of 3D reconstruction techniques, such as SfM, SLAM, or both SfM and SLAM.

At step 302, process 300 may include receiving the plurality of enhanced images (e.g., as a model input). N number of enhanced images may be received, where N is at least two. In some examples, dependent on a type of image processing technique used and whether medical device 102 includes additional sensors, other data types may be received as input in addition to the enhanced images. For example, if SLAM is used, and medical device 102 includes one or more sensors located at the distal tip of medical device 102 that are configured to detect a position of medical device 102 (and more particularly imaging device 110), the positional data detected may also be received as input. In examples where positional data of imaging device 110 is received, one enhanced image may be sufficient image input.

At step 304, process 300 may include detecting and extracting features from the plurality of enhanced images. For example, a feature detection process is performed to identify points of interest (e.g., feature points) within the enhanced images. Example feature points may include edges, corners, curves, blobs, textures, and patterns, among other similar examples. Once the features have been identified, the features are described and quantified. For example, a feature extraction process is performed to generate a descriptor for each feature point. The descriptor may be a vector (e.g., a numerical value) representing a local appearance around the respective feature point, such as color, texture, or shape. In some examples, a trained convolutional neural network (CNN) may be used to detect and extract the features from the enhanced images. In examples where one enhanced image may be sufficient image input, a similar feature detection and extraction process may be performed on the one enhanced image.

At step 306, process 300 may include identifying corresponding features across the plurality of enhanced images. For example, a feature matching process is performed to find corresponding feature points (e.g., similar feature points) between two or more of the enhanced images based on a comparison of descriptors for the features points across the enhanced images. In examples, where only one enhanced image is received along with positional data, process 300 may skip step 306 and instead proceed with step 308 directly from step 304.

At step 308, process 300 may include determining depth data for the features using the identified correspondence across the enhanced images. As previously described, the images, and thus the enhanced images, are 2D images providing only an x-coordinate position and a y-coordinate position for each pixel. Thus, only x-and y-coordinate positions are known for the feature points based on the enhanced images. To be able to generate a 3D representation, depth data representing a z-coordinate position for each of the feature points has to be obtained. Various techniques may be used to determine the depth of each feature point using the enhanced images.

As one illustrative example, stereo vision techniques may be used to determine the depth of a given feature point. At least a first image and a second image including the feature point may be identified from the enhanced images. Based on a position of imaging device 110 when the images were captured, the first image is from a first viewpoint left of the feature point and the second image is from a second viewpoint right of the feature point. A difference between a position of the feature point in the first image and the second image is determined, and the difference is used to estimate the depth of the feature point.

As another example, a similarity comparison of each pair of consecutive images from the enhanced images may be performed until the comparison reveals a pair that includes non-similar or non-aligning images. For example, a similarity of a first image and a second image comprising a first pair of consecutive images may be compared by determining whether or not the feature point within each of the first and second image align within a predetermined threshold on the 2D grid. If they do align within the threshold, a second pair of consecutive images comprising the second image and a third images may be compared, and so on, until a pair of consecutive images is determined to not meet the predetermined threshold for similarity. The two images in the pair of consecutive images that does not meet the predetermined threshold for similarity may be used to determine the depth for the feature point. For example, if the second image and third image fail to meet the similarity threshold, a difference between a position of the feature point in the second image and third image is determined, and the difference is used to estimate the depth of the feature point. In some examples, a CNN trained to identify the pair of consecutive images with non-similar or non-aligning images may be used to increase a speed at which the depth of the feature point is determined, and overall reduce inference time to reconstruct the 3D model.

As a further example, the depth of a feature point may be determined based on pixel intensity of image pixels associated with the feature point. For example, pixels associated with a first feature point representing a first feature further away from imaging device 110 (e.g., a feature deeper in the 3D environment) may be of a higher intensity, and thus appear darker, than pixels associated with a second feature point representing a second feature closer to imaging device 110. Thus, a model, such as a CNN, trained to determine depth of objects based on associated pixel intensity values may be used to determine the depth of a feature point based on the enhanced images.

The above-provided examples are non-limiting, illustrative examples. Any one or combination of techniques for determining depth of objects or features using image data may be used to perform step 308. Additionally, in examples where positional data of imaging device 110 is received in addition to the at least one enhanced image as model input, the positional data and the at least one enhanced image may be used to determine the depth at step 308.

At step 310, process 300 may include generating a point cloud, including points associated with the features (e.g., the features points), using the plurality of enhanced images (or the at least one enhanced image) and the depth data. For example, a position of each feature point in the point cloud may be based on the x- and y-coordinate positions of the feature point obtained from the 2D enhanced images, and the z-coordinate position of the feature point obtained from the depth data.

At step 312, process 300 may include generating the 3D model of the anatomical structure based on the point cloud. For example, the feature points in the cloud (e.g., vertices) may be connected with lines (e.g., edges) to form a 3D mesh representing or defining a geometry of the anatomical structure. The 3D mesh may then be texturized by adding image properties scraped from the enhanced images to generate the 3D model.

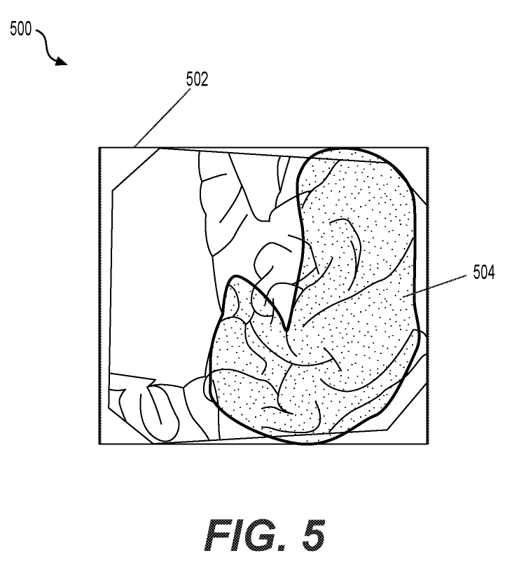

Turning back to FIG. 2, once the 3D model is generated, at step 208, process 200 may include generating an overlay including the 3D model for display. For example, the overlay may include the 3D model to be placed on top of (e.g., overlaid on) a 2D image captured by and received from imaging device 110 for display by display device(s) 106. The 2D image may be a latest image, also referred to herein as a current image, from the images received at step 202. An alignment between the 3D model and the 2D image may be determined such that the x- and y-coordinate positions for the feature points known in the 3D model align with x- and y-coordinate positions for corresponding feature points identified in the 2D image. An overlay image may then be generated for display by overlaying the 3D model on the 2D image based on the alignment. An example overlay image is shown in FIG. 5.

Continuing with the example where the anatomical structure is the stomach to be reduced in size during the ESG procedure, and as previously discussed with reference to step 202, a subset of the images captured at the beginning of the procedure may include the suture location markings along the stomach. For example, the markings may be a different color or texture to help allow visualization of the markings in the images. Accordingly, these markings may be example features that were identified, extracted, and matched from the images, and for which 3D pixel coordinate positions (e.g., x-, y-, and z-coordinate positions) were obtained as part of the 3D model generation. Therefore, the suture location markings may be included at the respective pixel coordinate positions within the 3D model that is overlaid on the 2D image to help guide suturing, particularly once the stomach begins to change in shape and size as the procedure progresses, as described in more detail below with reference to step 212.

In other examples, an initial 3D model reconstructed may be based only on images of the stomach captured prior to the marking of the stomach with the suture locations. In fact, because a placement of the suture locations may be dependent on a shape of the stomach, the initial 3D model displayed within a generated overlay may be used to help visualize the shape of the stomach to guide a determination of the suture locations and placement of the markings accordingly along the length of the stomach. Additionally, in some aspects, the initial 3D model may be provided as input to a separate suture location determination process, where the suture locations may be automatically determined based on the shape of the stomach represented by the initial 3D model, and presented to guide placement of the markings accordingly.

At step 210, process 200 may include determining a volume of the anatomical structure using the 3D model. The volume of the anatomical structure may be determined by integrating 3D data points within a boundary of the 3D model representing the anatomical structure. The boundary may be defined by naturally occurring anatomical features of the anatomical structure, predefined endpoints, or both.

Continuing with the example where the anatomical structure is the stomach to be reduced in size during the ESG procedure, a first side of the stomach (e.g., the greater curvature of the stomach) may include the suture location markings and a second, opposite side of the stomach may be defined by anatomy (e.g., the lesser curvature of the stomach). The suture location markings on the first side and the anatomy on the second side may be example endpoints defining the boundary of the stomach on which the volume determination is to be based. An initial or starting volume of the stomach may be determined at the beginning of the procedure (e.g., prior to any suturing). The initial volume may be provided for display on display device(s) 106. In some examples, the initial volume may be displayed separately from or in conjunction with (e.g., included or added as part of the overlay). Additionally, the initial volume may be recorded for storage in association with procedure notes or other patient-related records.

While the volume of the anatomical structure is described above as being determined using the 3D model, in other examples, the volume may be determined using the generated overlay that includes the 3D model.

At step 212, process 200 may include updating the 3D model, and adjusting the overlay and the volume based on the updated 3D model, as additional images of the anatomical structure are received. The additional images may be captured by, and received from, imaging device 110 throughout the procedure. The 3D model updating and subsequent overlay and volume adjustments may be performed in real time to enable monitoring of the shape and size of the anatomical structure (e.g., the stomach) as it dynamically changes throughout the procedure as a result of suturing, gas introduction or removal, or natural peristalsis, among other similar causes. For example, steps 204 and 206 may be continuously repeated to respectively enhance the additional images and reconstruct the updated 3D model based on the additional enhanced images as they are received such that the updated 3D model reflects the changes to the shape and size of the stomach.

In some examples, the reconstruction of the updated 3D model may also be based on one or more previous versions of the 3D model. For example, previous 3D pixel coordinates of features points or a positional relationship among the features points determined from previous 3D model(s) may be provided as model input in addition to the additional enhanced images. Among other advantages, using information from previous 3D model(s) to update the 3D model may help to maintain visualization of certain features that may otherwise be hidden or obscured in the additional enhanced images. For example, once one or more sutures are placed and tightened at respective suture location markings, a contour of the stomach changes and gastric folds may be deformed such that the folds now hide or obscure subsequent suture location markings. After the deformation has occurred, the additional images captured by imaging device 110 will no longer show these hidden or obscured suture location markings. However, the updated 3D model, and thus the adjusted overlay based on the updated 3D model, may maintain the suture location markings to enable a visualization thereof. For example, a positional relationship between the 3D pixel coordinate positions of the suture location markings and other feature points may be obtained from the 3D model reconstructed at step 206. This positional relationship may then be applied to the 3D pixel coordinate positions of the other feature points determined as part of updating the 3D model to extrapolate the 3D pixel coordinate positions of the suture location markings. In addition to facilitating accurate suture placement, the visualization of the suture location markings provided by the overlay helps to further prevent crossing of sutures as the tissue helix component of suturing system 113 grasps and retracts sections of the tissue corresponding to the suture location markings.

The adjusted overlay may include the updated 3D model to account for the shift or change in pixel coordinate positions of various features, as identified in the updated 3D model, resulting from the changes to the shape or size of the stomach. Similar to the overlay generation at step 208, the updated 3D model included in the adjusted overlay may be aligned with a current 2D image being displayed such that the x- and y-coordinate positions for the feature points identified in the 3D model correspond with x- and y-coordinate positions for the feature points in the 2D image.

Similar to the volume determination at step 210, adjusting the volume based on the updated 3D model may include integrating the 3D data points within the boundary of the anatomical structure in the updated 3D model. In the ESG procedure example, the adjusted volume may be provided for display to help the endoscopist monitor for when a target volume has been reached, and thus suturing may be completed. The adjusted volume may be provided for display separate from or as part of the adjusted overlay. In some examples, the target volume may be known by computing system 104, and an alert, notification, or other similar warning may be automatically generated and provided for display when the adjusted volume determined by computing system 104 reaches the target volume. For example, the computing system 104 may receive the target volume as input from the operator prior to the start of the procedure. As another example, based on a determination that the type of procedure to be performed is an ESG procedure (e.g., based on input received from operator or patient data obtained indicating the type of procedure to be performed), computing system 104 may obtain the target volume from a database or other similar data structure.

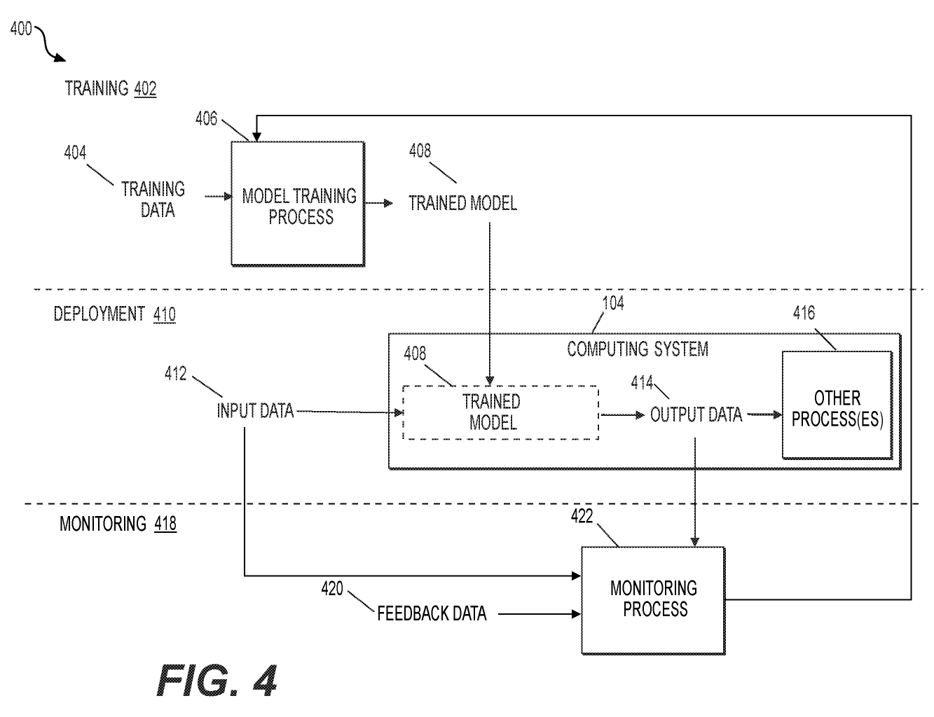

FIG. 4 is a block diagram showing an example process 400 for training, using, and monitoring a machine learning model ("model") executed as part of the 3D reconstruction process. In some aspects, a system or device other than computing system 104 is used to generate or train the model. For example, one or more of server-side system(s) 130 may include instructions for generating or training the model. A resulting trained model is then provided to computing system 104 for storage and use. In other aspects, the computing system 104 itself generates, trains, stores, and uses the model.

As depicted in FIG. 4, in some examples, process 400 may include a training phase 402, a deployment phase 410, and a monitoring phase 418. In training phase 402, step 406 of process 400 may include receiving and processing certain training data 404 to generate (e.g., build) a trained model 408 configured to reconstruct a 3D model of an anatomical structure, such as the stomach, based on 2D images thereof.

Training data 404 may include a plurality of training data sets. Each training data set may include a plurality of (e.g., at least two) images of the stomach captured from different angles. In some examples, each training data set may also include annotations or labels indicating 3D pixel coordinate positions for corresponding features across the images of the training data set for use as a ground truth. In some examples, one or more of the training data sets may optionally include positional data associated with an imaging device capturing the images.

Training data 404 is generated, received, or otherwise obtained from internal or external resources. Additionally, in some examples, a pretrained model may be received from internal or external resources that may be fine-tuned at step 406 using training data 404. Training data 404 may include internally collected images or images obtained from a third party or a public database. In some examples, the images may be real images captured by an endoscopic imaging device similar to imaging device 110 of medical device 102. However, in other examples, the images may be synthetically generated images. One or more preprocessing operations, such as noise reduction or contrast enhancement, may be performed on the images such that the images within the training data set are enhanced images. In some aspects, the ground truths or labels may be generated for the images (e.g., by human subject matter experts) or may be already associated with the images obtained from a third party or a public database.

Generally, a model includes a set of variables, e.g., nodes, neurons, filters, etc., that are tuned, e.g., weighted or biased, to different values via the application of training data 404. In some examples, the training process performed at step 406 employs supervised, unsupervised, semi-supervised, or reinforcement learning processes to train the model (e.g., to result in trained model 408). In some aspects, a portion of training data 404 is withheld during training or used to validate trained model 408.

When supervised learning processes are employed, the annotations or labels facilitate the learning process by providing the ground truth. For example, training proceeds by feeding enhanced images from a training data set (e.g., a sample) into the model, the model having variables set at initialized values, e.g., at random, based on Gaussian noise, a pre-trained model, or the like. The model outputs a predicted 3D model (e.g., yielding predicted 3D pixel coordinate positions for corresponding features across the images of the training data set). The output is compared with the corresponding annotations and labels (e.g., the ground truth) to determine an error, which is then backpropagated through the model to adjust the values of the variables. This process is repeated for a plurality of samples at least until a determined loss or error is below a predefined threshold. In some examples, some of training data 404 is withheld and used to further validate or test trained model 408.

Once trained, trained model 408 is stored (e.g., in memory 114) and subsequently executed by computing system 104 during deployment phase 410. For example, during deployment phase 410, trained model 408 receives input data 412. Input data 412 may include the images of the anatomical structure that are captured by imaging device 110 during the medical procedure and pre-processed to generate enhanced images for input to trained model 408 (e.g., the images received and pre-processed at step 202 and step 204 of process 200, respectively). Optionally, input data 412 may also include positional data. Trained model 408 generates and outputs a 3D model of the anatomical structure as output data 414. The output data 414 may then be provided for use in one or more other processes 416, such as overlay generation and volume determination to enable changes in the shape and size (e.g., volume of the stomach) to be determined in real time as the medical procedure is occurring.

Trained model 408 may be a continuously adaptive model that, in subsequent executions of trained model 408 during deployment phase 410, is configured to receive and process one more previous 3D models of the anatomical structure (e.g., previous output data 414 of trained model 408) along with additional images received as new input data. In other words, trained model 408 may be configured to adapt itself based on past training and outputs, in addition to current conditions to account for changes to the anatomical structure occurring during the procedure and captured in the additional images received.

Additionally, during monitoring phase 418, feedback data 420 is collected. Feedback data 420 may include an indication of an accuracy (or lack thereof) of the generated 3D model. In some examples, feedback data 420 may be based on human expert feedback (e.g., model developers and/or operators). In other examples, feedback data 420 may be produced by trained model 408 itself. During monitoring process 422, feedback data 420 is analyzed along with input data 412 to determine an accuracy of output data 414. In some examples, based on the analysis, process 400 returns to training phase 402, where at step 406 the values of one or more variables of trained model 408 are adjusted to re-train the model. For example, a new training data set may be generated based on input data 412 and feedback data 420 (e.g., feedback data 420 may include accurate 3D pixel coordinate positions for features for uses as annotations or labels for input data 412), and fed into trained model 408 to cause the adjusting of the variables.

Process 400 described above is provided merely as an example, and can include additional, fewer, different, or differently arranged aspects than depicted in FIG. 4.

FIG. 5 depicts an example overlay image 500. Overlay image 500 may be displayed on one of display device(s) 106. Overlay image 500 may include a 3D model 504 of the anatomical structure (e.g., of the stomach) reconstructed as described with reference to FIGS. 2 and 3 that is overlaid on a current image 502 of the anatomical structure captured by and received from imaging device 110. As shown in FIG. 5, 3D model 504 is generated based on images captured prior to the marking of the suture locations at the beginning of the procedure, and thus such suture location markings are not included in the 3D model 504. Placement of the suture location markings may be dependent on a shape of the stomach. Thus, in some examples, the shape of the stomach, as visualized by 3D model 504 included in overlay image 500, may assist the endoscopist in determining where to place the suture locations and corresponding markings along the stomach.

After the suture locations have been marked, and additional images including the markings have been captured by and received from imaging device 110 for use in updating 3D model 504, the updated 3D model (not shown) may include the suture location markings to help guide suturing. Visualization of the suture location markings within the updated 3D model and subsequent updated 3D models may be particularly helpful as the procedure progresses, as the markings may become hidden or obscured from a view of the imaging device 110, and thus the image on which the updated 3D model is overlaid on. In some examples, overlay image 500 may also include other data useful to the endoscopist, such as a current volume determined for the stomach using the 3D model 504 or updated 3D model. In other examples, the volume data is presented separately from overlay image 500.

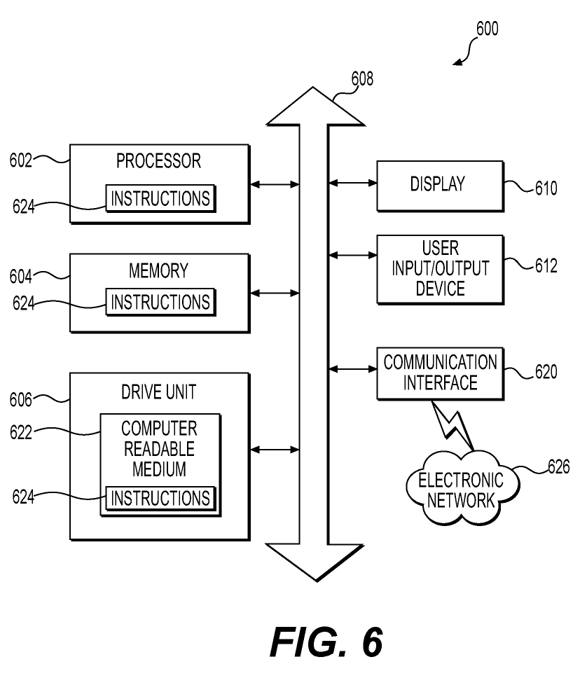

FIG. 6 depicts an example of a computer 600. FIG. 6 is a simplified functional block diagram of computer 600 that may be configured as a device for executing processes, steps, or operations depicted in, or described with respect to, FIGS. 2-5 and, according to exemplary aspects described herein. For example, computer 600 may be configured as one or more of medical device 102, accessory device(s) 103, computing system 104, display device(s) 106, server-side system(s) 130, or another device or component according to exemplary aspects described herein. In various aspects, any of the systems herein may be or include computer 600 including, e.g., a data communication interface 620 for packet data communication. Computer 600 may communicate with one or more other computers, for example, using an electronic network 626 (e.g., via data communication interface 620). Electronic network 626 may include a wired or wireless network, for example, similar to network 140 depicted in FIG. 1.

Computer 600 also may include a central processing unit ("CPU"), in the form of one or more processors 602, for executing program instructions 624. In some examples, processors 602 may be or include one or more field-programmable gate arrays (FPGAs). Program instructions 624 may include at least instructions for performing 3D reconstruction, volume determination, and overlay generation (e.g., if computer 600 is computing system 104).

Computer 600 may include an internal communication bus 608. Computer 600 may also include a drive unit 606 (such as read-only memory (ROM), hard disk drive (HDD), solid-state disk drive (SDD), etc.) that may store data on a computer readable medium 622 (e.g., a non-transitory computer readable medium), although computer 600 may receive programming and data via network communications. Computer 600 may also have a memory 604 (such as random-access memory (RAM)) storing instructions 624 for executing techniques presented herein. It is noted, however, that in some aspects, instructions 624 may be stored temporarily or permanently within other modules of computer 600 (e.g., processor 602 or computer readable medium 622). Computer 600 also may include user input and output devices 612 or a display 610 to connect with input or output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as "products" or "articles of manufacture" typically in the form of executable code or associated data that is carried on or embodied in a type of machine-readable medium. "Storage" type media include any or all of the tangible memory of the computers, processors or the like, or associated modules thereof, such as various semiconductor memories, tape drives, disk drives and the like, which may provide non-transitory storage at any time for the software programming. All or portions of the software may, at times, be communicated through the Internet or various other telecommunication networks. Such communications, e.g., may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible "storage" media, terms such as computer or machine "readable medium" refer to any medium that participates in providing instructions to a processor for execution.

While principles of this disclosure are described herein with the reference to illustrative examples for particular applications, it should be understood that the disclosure is not limited thereto. Those having ordinary skill in the art and access to the teachings provided herein will recognize additional modifications, applications, and substitution of equivalents all fall within the scope of the examples described herein. Accordingly, the invention is not to be considered as limited by the foregoing description.

1. A computer-implemented method for monitoring changes to an anatomical structure throughout a medical procedure, the method comprising:
receiving a plurality of images of the anatomical structure captured by a medical imaging device as the medical procedure is initiated, wherein one or more steps of the medical procedure are performed based on one or more of a shape or a volume of the anatomical structure, and the shape and the volume of the anatomical structure change throughout the medical procedure;
reconstructing a three-dimensional (3D) model of the anatomical structure based on the plurality of images;
generating an overlay including the 3D model for display on an image from the plurality of images;
determining an initial volume of the anatomical structure using the 3D model; and
updating the 3D model as additional images of the anatomical structure captured by the medical imaging device are received throughout the medical procedure, wherein the overlay and the initial volume are adjusted based on the updated 3D model to monitor the changes to the shape or the volume of the anatomical structure throughout the medical procedure.

2. The computer-implemented method of claim 1, wherein reconstructing the 3D model based on the plurality of images comprises:
detecting and extracting features from the plurality of images;
identifying a correspondence among the features across the plurality of images;
determining depth data for the features using the identified correspondence across the plurality of images;
generating a point cloud including points associated with the features using the plurality of images and the depth data; and
generating the 3D model of the anatomical structure based on the point cloud.

3. The computer-implemented method of claim 2, wherein determining the depth data for the features comprises determining a depth of each feature based on one of:
a difference determined between a position of the feature in a first image, from the plurality of images, associated with a first viewpoint of the feature and a second image, from the plurality of images, associated with a second viewpoint of the feature;
a difference determined between positions of the feature in a pair of consecutive images, from the plurality of images, identified as failing to meet a similarity threshold; or
intensity values of pixels associated with the feature across the plurality of images.

4. The computer-implemented method of claim 2, wherein generating the point cloud comprises:
establishing a 3D point for each feature using a x-coordinate position and a y-coordinate position for the feature obtained from the plurality of images and a z-coordinate position for the feature obtained from the depth data.

5. The computer-implemented method of claim 2, wherein generating the 3D model of the anatomical structure based on the point cloud comprises:
connecting the points in the point cloud to form a 3D mesh representing a geometry of the anatomical structure; and
texturizing the 3D mesh by adding image properties from the plurality of images to generate the 3D model.

6. The computer-implemented method of claim 2, wherein a Structure for Motion (SfM) technique, a Simultaneous Localization and Mapping (SLAM) technique, or a combination of the SfM technique and the SLAM technique are configured to reconstruct the 3D model.

7. The computer-implemented method of claim 1, further comprising:
performing one or more preprocessing operations on the plurality of images to generate a plurality of enhanced images; and
reconstructing the 3D model of the anatomical structure based on the plurality of enhanced images.

8. The computer-implemented method of claim 1, wherein determining the initial volume of the anatomical structure using the 3D model comprises:
integrating 3D data points within a defined boundary of the 3D model representing the anatomical structure, wherein the defined boundary is defined by one or more of naturally occurring anatomical features of the anatomical structure or predefined endpoints.

9. The computer-implemented method of claim 1, further comprising:
providing the initial volume and adjustments to the initial volume for display throughout the medical procedure.

10. The computer-implemented method of claim 9, wherein the initial volume and the adjustments to the initial volume are included in the overlay and the adjusted overlay, respectively.

11. The computer-implemented method of claim 1, wherein the medical procedure is associated with a volume reduction of the anatomical structure from the initial volume to a target volume, and wherein the method further comprises:
determining, based on the adjustment to the initial volume, the target volume has been reached; and
generating, and providing for display, a notification that the target volume has been reached.

12. The computer-implemented method of claim 1, wherein generating the overlay including the 3D model for display on the image from the plurality of images comprises:
determining an alignment between the 3D model and the image such that x-coordinate positions and y-coordinate positions for feature points identified in the 3D model correspond with x-coordinate positions and y-coordinate positions for corresponding feature points in the image; and
generating an overlay image for display by overlaying the 3D model on the image based on the alignment.

13. The computer-implemented method of claim 1, wherein the medical procedure includes a suturing procedure, wherein one step of the one or more steps of the medical procedure performed based on the one or more of the shape or the volume of the anatomical structure is a determination of a plurality of locations to place a plurality of sutures, and wherein the method comprises:
determining the plurality of locations to place the plurality of sutures based on the 3D model.

14. The computer-implemented method of claim 1, wherein the medical procedure includes a suturing procedure, wherein the 3D model includes a plurality of markings that were placed on the anatomical structure to correspond to a plurality of suture locations based on a presence of the plurality of markings in at least a subset of the plurality of images, and wherein updating the 3D model as the additional images of the anatomical structure are received throughout the medical procedure comprises:
reconstructing the updated 3D model based on the additional images and the 3D model to cause remaining markings of the plurality of markings to be included in the updated 3D model even when the remaining markings are not visible in the additional images received.

15. The computer-implemented method of claim 1, wherein the anatomical structure is a stomach, and the medical procedure is an endoscopic sleeve gastroplasty performed to reduce a volume of the stomach.

16. A computer-implemented method for monitoring changes to an anatomical structure throughout a medical procedure, the method comprising:
receiving a plurality of images of the anatomical structure captured by a medical imaging device as the medical procedure is initiated, wherein the medical procedure is associated with a volume change of the anatomical structure;
determining depth data associated with the plurality of images;
reconstructing a three-dimensional (3D) model of the anatomical structure based on the plurality of images and the depth data;
determining an initial volume of the anatomical structure using the 3D model; and
updating the 3D model as additional images of the anatomical structure captured by the medical imaging device are received throughout the medical procedure, wherein the initial volume determined is adjusted based on the updated 3D model to monitor the volume change of the anatomical structure throughout the medical procedure.

17. The computer-implemented method of claim 16, further comprising:
generating an overlay including the 3D model for display on an image from the plurality of images, wherein the overlay is adjusted based on the updated 3D model.

18. The computer-implemented method of claim 17, further comprising:
causing the initial volume and the adjusted volume to be displayed as part of the overlay and the adjusted overlay, respectively.

19. A computer-implemented method for monitoring changes to an anatomical structure throughout a medical procedure, the method comprising:
receiving a plurality of images of the anatomical structure captured by a medical imaging device as the medical procedure is initiated, wherein the medical procedure includes suturing to reduce a volume of the anatomical structure, and wherein at least a subset of the plurality of images include a plurality of markings placed on the anatomical structure at a plurality of suture locations;
determining depth data associated with the plurality of images;
reconstructing a three-dimensional (3D) model of the anatomical structure based on the plurality of images and the depth data, the 3D model including the plurality of markings;
generating an overlay including the 3D model for display on an image from the plurality of images; and
updating the 3D model as additional images of the anatomical structure captured by the medical imaging device are received throughout the medical procedure, wherein the overlay is adjusted based on the updated 3D model to monitor changes to a shape and size of the anatomical structure as the suturing is performed to reduce the volume of the anatomical structure, and wherein the updated 3D model maintains remaining markings of the plurality of markings to facilitate the suturing.

20. The computer-implemented method of claim 19, further comprising:
determining an initial volume of the anatomical structure using the 3D model, wherein the initial volume determined is adjusted based on the updated 3D model to monitor a volume change of the anatomical structure throughout the medical procedure.
